(19) United States
(12) Patent Application Publication
(10) Pub. No.: US 2008/0298518 A1
(43) Pub. Date: Dec. 4, 2008

(54) Automatic Gain Control Unit of a Receiver

(76) Inventor: Gopalan Krishnamurthy, Naperville, IL (US)

Correspondence Address: MCCRACKEN & FRANK LLP, 311 S. WACKER DRIVE, SUITE 2500, CHICAGO, IL, 60606, US

(21) Appl. No.: 11/631,700

(22) PCT Filed: Aug. 12, 2005
(86) PCT No.: PCT/US2005/028907

§ 371 Date: Jan. 5, 2007

Related U.S. Application Data
(60) Provisional application No. 60/601,026, filed on Aug. 12, 2004.

(51) Int. Cl. H04L 27/08

(52) U.S. Cl. 375/345

(57) ABSTRACT

An automatic gain control (AGC) circuit that includes an RF amplifier with first and second distinct active gain control regions, wherein a gain of the RF amplifier varies during operation in the active gain control regions

### CROSS REFERENCE TO RELATED APPLICATIONS

This application claims the benefit of U.S. Provisional Application No. 60/601,026, filed Aug. 12, 2004, and entitled “Advanced Digital Receiver.”

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates generally to digital communication techniques, and more particularly, to an apparatus for and method of adjusting the automatic gain control unit of a receiver.

2. Description of the Background of the Invention

Signal communications systems transmit a data stream from a transmitter to a receiver through a communication channel. Specifically, a transmitter modulates a carrier wave in response to the data stream to generate a radio frequency (RF) signal and transmits the RF signal through the communication channel. An analog front-end of a receiver detects the RF signal from the communication channel and down-mixes the RF signal to develop a near-baseband intermediate frequency (IF) signal. The IF signal is thereafter demodulated and decoded to develop estimates of the data stream.

The analog front-end is designed with automatic gain control (AGC) that presents an IF signal with constant power to the demodulation circuitry even as the power level of the RF signal detected from the channel varies. To achieve this, the front-end incorporates an RF amplifier that amplifies the RF signal, a mixer to generate an IF signal from the amplified RF signal, and an IF amplifier to amplify the generated IF signal to develop an amplified IF signal that is presented to the demodulation circuitry. Control circuitry in the front-end monitors the power level of the signal received from the channel and adjusts the gains of the RF and IF amplifiers accordingly so that the power level at the output of the front-end is maintained at a constant level.

Typical front-ends use a two-mode AGC, which operates in a first operating mode if the power level of the received signal is low and in a second operating mode if the power level of the received signal is high. The AGC that is operating in the first operating mode sets the gain of the RF amplifier to a maximum level and adjusts the gain of the IF amplifier as necessary to produce an output signal of constant power. If the power level of the received signal is high, then the AGC operates in the second operating mode whereby the front-end sets the gain of the IF amplifier to a constant gain and adjusts the gain of the RF amplifier as needed to maintain an output signal of constant power.

Having two operating modes in the AGC prevents saturation of the RF amplifier when the receiver receives a signal with a high power level. However, saturation of the RF amplifier can still occur, especially in situations when signals in adjacent channels interfere with the signal in the desired channel. This is because the control circuitry of a typical front-end selects the operating mode of the AGC by averaging the received signal power in a desired channel without considering the power levels of signals in adjacent channels. If the power level of the signal received in the desired channel is low but the power level of a signal in an adjacent channel is high, the AGC will operate in the first operating mode (i.e., maximum RF gain) and the strength of the signal in the adjacent channel will cause the RF amplifier to become saturated and cause distortion of the signal in the desired channel. In addition, the two-mode AGC does not allow the front end to compensate for fast changes in signal power that, for example, could be caused by reflections from large moving objects (e.g., trucks, planes, etc.) because the gain of the RF amplifier cannot be adjusted quickly without causing an instability in the gain control loop due to excessive delays in the control path.

### SUMMARY OF THE INVENTION

According to one aspect of the invention, an automatic gain control (AGC) circuit comprises an RF amplifier that has first and second distinct active gain control regions, wherein a gain of the RF amplifier varies during operation in the active gain control regions.

According to another aspect of the invention, a circuit for amplifying a signal includes a first amplifier that develops a first amplified signal from the signal, wherein a first gain is associated with the first amplifier. The circuit further includes a second amplifier that generates a second amplified signal from a signal derived from the first amplified signal. In addition, the circuit includes a controller that is responsive to the power level of the signal for selecting an operating mode for the circuit from at least three operating modes and for controlling the first gain and the second gain in accordance with the operating mode.

Other aspects and advantages of the present invention will become apparent upon consideration of the following detailed description.

### BRIEF DESCRIPTION OF THE DRAWINGS

FIG. 1 shows a receiver in a communications system;

FIG. 2 depicts an embodiment of an automatic gain control unit (AGC) of an analog front-end of the receiver of FIG. 1;

FIG. 3A depicts an IF gain control curve of the AGC unit of FIG. 2;

FIG. 3B depicts an RF gain control curve of the AGC unit of FIG. 2;

FIG. 4 comprises a state diagram illustrating operation of a control system of the AGC unit of FIG. 2;

FIG. 5 comprises a block diagram of a control system of the AGC unit of FIG. 2 that operates in a manner similar to the operation illustrated by FIG. 4;

FIG. 6A depicts a gain characteristic curve of an IF amplifier in the AGC unit of FIG. 2;

FIG. 6B depicts a flow chart of a selector of the controller of FIG. 4; and

FIGS. 7A-7C are a series of diagrams on a synchronized time scale illustrating one aspect of the operation of the controller of FIG. 2 in response to received power level.

### DETAILED DESCRIPTION OF THE PREFERRED EMBODIMENTS

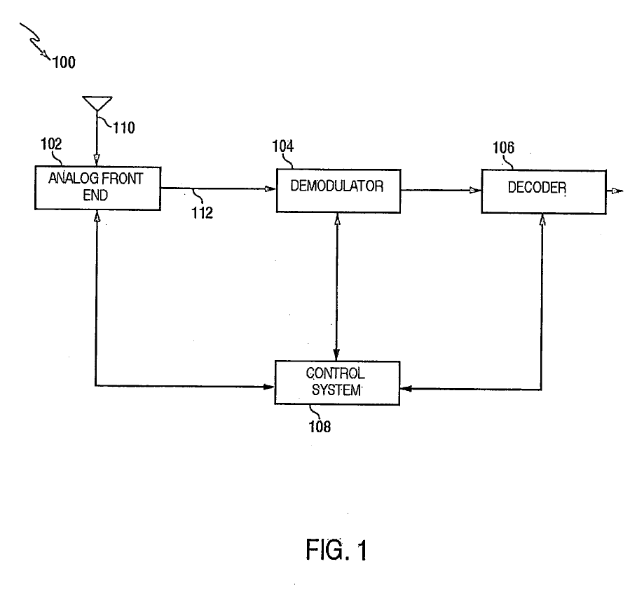

FIG. 1 illustrates a receiver 100 suitable for receipt and decoding of a signal transmitted through a channel. The receiver 100 comprises an analog front-end 102, a demodulator 104, and a decoder 106. In addition, a control system 108 monitors and controls the operation of the various components of the receiver 100. The analog front-end receives an RF signal at an input 110 and develops an IF signal at an output 112. The control system 108 operates the front-end 102 such that the power level of the IF signal developed at the output 112 is maintained at a desired level even as the power level of the RF signal at the input 110 fluctuates.

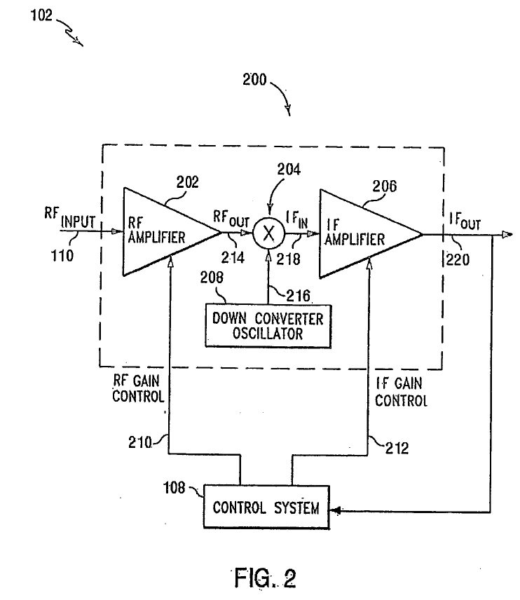

FIG. 2 depicts an automatic gain control (AGC) unit 200 of the analog front-end 102 of the receiver 100. The AGC unit 200 comprises an RF amplifier 202, a mixer 204, an IF amplifier 206, and a down-converter oscillator 208. The AGC unit 200 further provides additional control signals to the control system 108 including an RF GAIN CONTROL signal on a line 210 to control the gain (RF_{GAIN}) of the RF amplifier 202 and an IF GAIN CONTROL signal on a line 212 to control the gain (IF_{GAIN}) of the IF amplifier 206. Only signals relevant to an understanding of the present embodiment are shown herein.

The RF amplifier 202 of the analog front-end 102 receives a signal RF_{INPUT} from the channel at the input 110. The RF amplifier 202 amplifies the signal RF_{INPUT} to develop a signal RF_{OUT} on a line 214 that is provided to the mixer 204. The mixer 204 uses a stable local oscillator output signal received on a line 216 from the down-converter oscillator 208 to down-convert the RF_{OUT} signal to an intermediate frequency signal IF_{IN} on a line 218. The IF amplifier 206 receives the IF_{IN} signal from the mixer 204 and amplifies the IF_{IN} signal to generate a signal IF_{OUT} on a line 220. Some embodiments may use components such as a Bandpass Filter between the mixer 204 and the IF amplifier 206 in order to remove out of band interference from the signal IF_{IN}. Referring back to FIG. 1, it can be appreciated that the IF_{OUT} signal on the line 220 is identical to the analog near-baseband IF signal on the output line 112 provided by the analog front-end receiver 102 to the demodulator 104.

The control system 108 provides the RF GAIN CONTROL signal on the line 210 that determines the RF_{GAIN} applied by the RF amplifier 202 in accordance with a predetermined gain characteristic curve of the RF amplifier 202. Similarly, the control system 108 provides the IF GAIN CONTROL signal on line 212 that determines the IF_{GAIN} applied by the IF amplifier 206 in accordance with a predetermined gain characteristic curve of the IF amplifier 206. The control system 108 selectively controls the RF_{GAIN} and the IF_{GAIN} using the RF GAIN CONTROL and IF GAIN CONTROL signals on lines 210 and 212, respectively, to optimize the signal-to-noise and distortion performance of the analog front end 102, even in the presence of interference from adjacent channels.

In one embodiment, the control system 108 estimates the power level RF_{PL} of the received RF_{INPUT} signal from the RF_{GAIN}, the IF_{GAIN}, and the power level of the IF_{OUT} signal as follows:

RF_{PL}=IF_{OUT}−(RF_{GAIN}+IF_{GAIN}+K)

where K is a predetermined constant and measurements are in dB or dBm. It should be apparent that the value of the RF_{GAIN} in the above equation can be estimated from the value of the RF GAIN CONTROL signal on the line 210 and the gain characteristic curve of the RF amplifier 202. Similarly, the value of the IF_{GAIN} can be estimated using the value of the IF GAIN CONTROL signal on the line 212 and the gain characteristic curve of the IF amplifier 206.

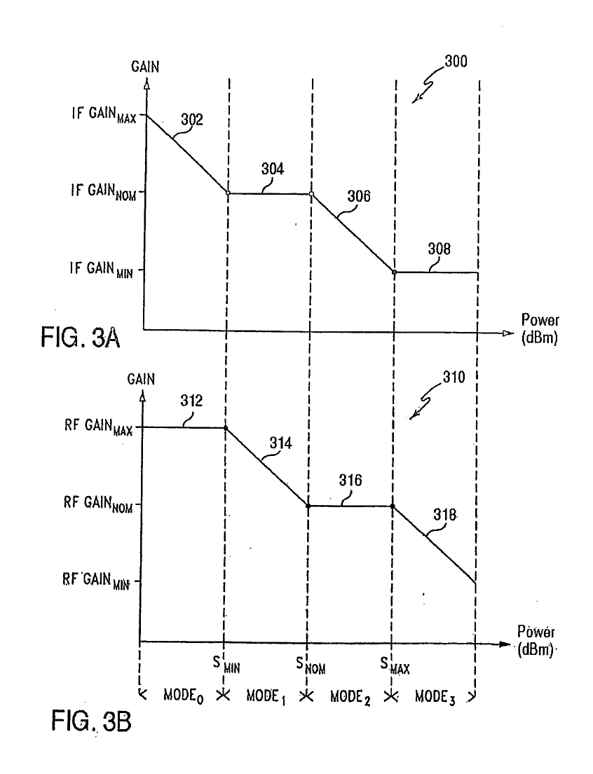

The control system 108 operates the AGC unit 200 in one of four operating modes MODE₀, MODE₁, MODE₂, and MODE₃ in accordance with the calculated value of RF_{PL}. FIG. 3A depicts an IF gain control curve 300 that shows the IF_{GAIN} applied by the IF amplifier 206 during the operating modes MODE₀, MODE₁, MODE₂, and MODE₃. The IF gain control curve 300 has a first active region 302, a first static region 304, a second active region 306, and a second static region 308 in which the IF amplifier 206 is operable during operation in MODE₀, MODE₁, MODE₂, and MODE₃, respectively. Similarly, as shown in FIG. 3B, the RF_{GAIN} applied by the RF amplifier 202 is controlled in accordance with the RF gain control curve 310. The RF gain control curve 310 has a first static region 312, a first active region 314, a second static region 316, and a second active region 318 that are in effect during MODE₀, MODE₁, MODE₂, and MODE₃, respectively.

The control system 108 operates the AGC unit 200 in MODE₀ when the power level RF_{PL} of the RF_{INPUT} signal is less than a first threshold level S_{MIN}. The control system 108 operates the AGC unit 200 in MODE₁ when the RF power level RF_{PL} is greater than S_{MIN} but less than a second threshold level S_{NOM}. Similarly, the AGC unit 200 operates in MODE₂ when the RF power level RF_{PL} is greater than S_{NOM} but less than a third threshold level S_{MAX}. Finally, the control system 108 operates the AGC unit 200 in MODE₃ when the RF power level RF_{PL} is greater than the level S_{MAX}. Although not shown in FIG. 3A and FIG. 3B, some embodiments of the control system 108 incorporate a degree of hysteresis between the certain ones or all of the different modes of operation of the AGC unit 200. Those of skill in the art would recognize that fewer or more operating modes can be used without departing from the spirit of the invention.

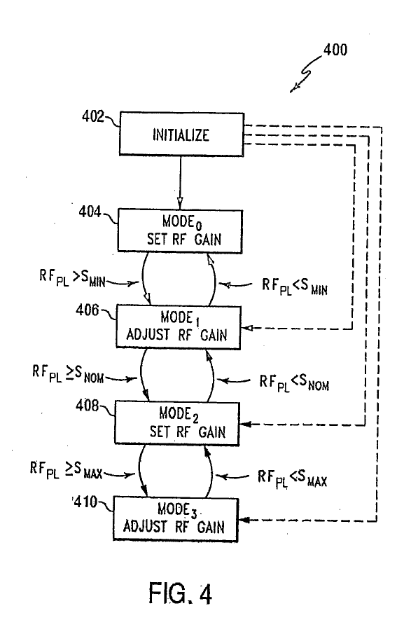

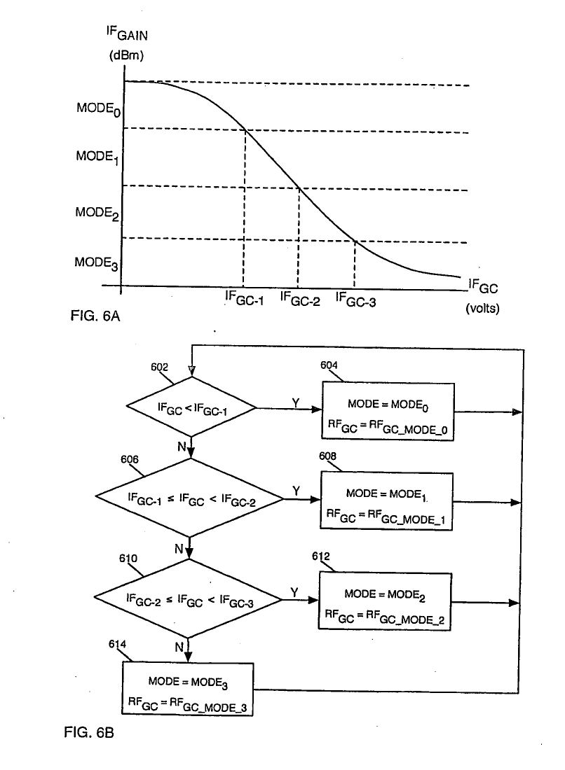

FIG. 4 illustrates a state diagram 400 of the control system that may be used to control the AGC unit 200. At block 402, “Initialize,” control system 108 initializes the various elements of the AGC unit 200. Block 402 then calculates the power level RF_{PL} of the received signal, RF_{INPUT} and, in some embodiments, causes the AGC unit 200 to proceed to block 404. In other embodiments, shown as a dashed line in FIG. 6, the control system 108 compares the calculated RF_{PL} to the threshold values S_{MIN}, S_{NOM}, and S_{MAX} and selects an appropriate operating mode for the AGC unit 200 as described below. For example, the AGC unit 200 directly transitions from block 402, “Initialize,” to block 406, “MODE₁-Adjust RF Gain,” when S_{NOM}>RF_{PL}>S_{MIN} without first transitioning into MODE₀.

At block 404, “MODE₀-SET RF GAIN,” the IF amplifier 206 operates in the first active region 302 and the control system 108 adjusts the signal controlling IF_{GAIN} to control the gain of the IF amplifier 206 while the RF amplifier 202 operates in the first static region 312 with the RF_{GAIN} set to RF GAIN_{MAX}. In this mode, the control system 108 adjusts the signal controlling IF_{GAIN} linearly with respect to the power level RF_{PL} so that IF_{GAIN} is in a range between IF GAIN_{MAX} and IF GAIN_{NOM}. It can be appreciated that setting the RF amplifier gain to RF GAIN_{MAX}, when RF_{PL} is less than S_{MIN} provides the greatest signal amplification at the output of the IF amplifier 206 while overcoming noise present at the RF amplifier input coupled to the line 110. The AGC unit 200 then transitions to block 406 when RF_{PL} is greater than S_{MIN}.

At block 406, “MODE₁-Adjust RF Gain,” the control system 108 operates the RF amplifier 202 in the first active region 314 of the RF gain control curve 310. Depending upon the power level of the RF_{INPUT} signal, the signal controlling the RF_{GAIN} is slewed so that the RF_{GAIN} is between RF GAIN_{MAX} and RF GAIN_{NOM}. The RF_{GAIN} is adjusted in accordance with the power level RF_{PL} so that the IF_{GAIN} is maintained at a constant gain of IF GAIN_{NOM}. Changes in the RF_{PL} while the AGC is operating in this mode may cause the IF_{GAIN} to deviate from IF GAIN_{NOM}. However, the control system 108 adjusts the RF_{GAIN} so that the IF_{GAIN} signal returns to IF GAIN_{NOM} Preferably, the signal controlling the RF_{GAIN} is adjusted linearly with respect to the power level RF_{PL}. Adjusting the RF_{GAIN} while maintaining the IF_{GAIN} constant allows the AGC unit 200 to compensate for strong adjacent channel interference without significantly degrading the receiver performance. If RF_{PL}≧S_{NOM}, the control system 108 transitions the AGC unit 200 to block 408. However, if the power level RF_{PL} becomes less than S_{MIN}, the control system 108 transitions the AGC unit 200 to block 404.

At block 408, “MODE₂-SET RF GAIN,” the control system 108 operates the RF amplifier 202 in the static region 316 by setting the RF_{GAIN} to RF GAIN_{NOM}. The control system 108 operates the IF amplifier 206 in the second active region 306 and adjusts the signal controlling IF_{GAIN} so that the IF_{GAIN} is in a range between IF GAIN_{NOM} and IF GAIN_{MIN}. Preferably, the IF_{GAIN} is adjusted linearly with respect to RF_{PL}. This allows the AGC unit 200 to adjust for strong adjacent channel interference without further degrading the signal-to-noise performance at the output of the IF amplifier 206. If RF_{PL}<S_{NOM}, the control system 108 transitions the AGC unit 200 to block 406. Otherwise, if RF_{PL}≧S_{MAX}, the control system 108 transitions the AGC unit 200 to block 410.

At block 410, “MODE₃-Adjust RF Gain,” the control system 108 operates the RF amplifier 202 in the second active region 318 by adjusting the signal that controls the RF_{GAIN} so that RF_{GAIN} is in a range between RF GAIN_{NOM} and RF GAIN_{MIN} while maintaining the IF_{GAIN} at a constant gain of IF GAIN_{MIN}. As described above with respect to “MODE₁-Adjust RF GAIN,” the IF_{GAIN} may deviate from IF GAIN_{MIN} in response to a change in RF_{PL}. However, the control system adjusts the RF_{GAIN} such that the IF_{GAIN} returns to IF GAIN_{MIN}. The RF_{GAIN} is generally adjusted linearly with respect to the power level RF_{PL}. This allows the AGC unit 200 to adjust for a received RF_{INPUT} signal with high power. If RF_{PL}<S_{MAX}, the control system 108 transitions the AGC unit 200 back to block 408. Although not indicated in FIG. 4, it can be understood that in some embodiments of the state diagram 400 include techniques to provide hysteresis when transitioning between the various modes. Illustratively, some embodiments of the state diagram 400 transition the AGC unit 200 from block 410 to block 408 when RF_{PL}<S_{MAX}−Δ, where Δ signifies the desired degree of hysteresis. It can be understood that transitions of the AGC unit 200 between other blocks of the state diagram 400 may also include a similar offset.

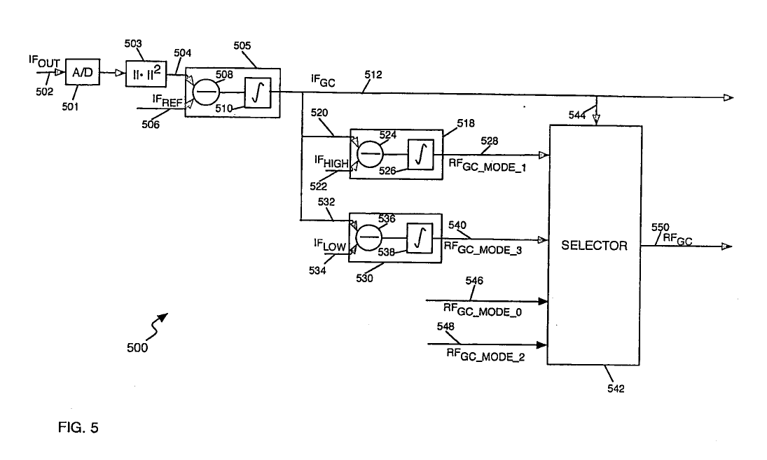

Estimating the RF_{PL} from the RF_{GAIN} and the IF_{GAIN} of the RF amplifier 202 and IF amplifier 206, respectively, may difficult to implement. To overcome this, some implementations of the control system 108 may use the IF_{OUT} signal developed at the line 220 of FIG. 2 to select the operating mode of the AGC 200. FIG. 5 shows a block diagram of a control system 500 that can be used in such an implementation. An analog to digital converter 501 receives the signal IF_{OUT} on the line 502 and provides a digital value corresponding to the signal to a squarer 503 that develops a signal on a line 504 that represents the power level of the signal IF_{OUT}. A comparator block 505 receives the signal on the line 504 and a reference signal IF_{REF} on a line 506. The signal IF_{REF} represents the power level of the signal desired at the output line 220 of the AGC 200. A subtractor 508 calculates a difference between the IF_{OUT} and IF_{REF} signals and provides the result to an integrator 510, which averages the difference between the IF_{OUT} and IF_{REF} signals over time and develops a signal IF_{GC} on a line 512. The actual gain IF_{GAIN} applied by the IF amplifier 206 is determined by the IF_{GC} signal in accordance with the gain characteristic curve of the IF amplifier 206.

A comparator 518 receives the IF_{GC} signal on a line 520 and a signal IF_{HIGH} on a line 522. The signal IF_{HIGH} is the IF GAIN CONTROL signal that must provided to the IF amplifier 206 on a line 212 to set the gain thereof to IF GAIN_{NOM}. A subtractor 524 in the comparator calculates a difference between the IF_{GC} and IF_{HIGH} signals and provides the resulting signal to an integrator 526. The integrator 526 averages the difference over time and develops a signal RF_{GC}_{_{—}}_{MODE}_{_{—}}₁ on a line 528. The signal RF_{GC}_{_{—}}_{MODE}_{_{—}}₁ corresponds to the RF GAIN CONTROL signal that must provided to the RF amplifier 202 on the line 210 when the gain of the IF amplifier 206 is set to IF GAIN_{NOM} to cause the AGC unit 200 to produce an output signal on the output line 220 having a power level IF_{REF}.

A comparator 530 receives the IF_{GC} signal on a line 532 and a signal IF_{LOW} on a line 534. The signal IF_{LOW} is the IF GAIN CONTROL signal that must be provided to the IF amplifier 206 on a line 212 to sets the gain thereof to IF GAIN_{MIN}. A subtractor 536 in the comparator calculates a difference between the IF_{GC} and IF_{LOW} signals and provides the resulting signal to an integrator 538. The integrator 538 averages the difference between the two signals over time and develops a signal RF_{GC}_{_{—}}_{MODE} _{_{—}}₃ on a line 540. The signal RF_{GC}_{_{—}}_{MODE}_{_{—}}₃ corresponds to the RF GAIN CONTROL signal that must be provided the RF amplifier 202 on the line 210 when the gain of the IF amplifier 206 is set to IF GAIN_{MIN} so that the AGC unit 200 produces an output signal on the line 220 having a power level IF_{REF}.

A selector 542 receives the signals RF_{GC}_{_{—}}_{MODE}_{_{—}}₁, RF_{GC}_{_{—}}_{MODE}_{_{—}}₃, and IF_{GC} on the lines 528, 540, and 544, respectively. In addition, the selector 542 receives signals RF_{GC}_{_{—}}_{MODE}_{_{—}}₀ and RF_{GC}_{_{—}}_{MODE}_{_{—}}₂ on the lines 546 and 548, respectively. The signals RF_{GC}_{_{—}}_{MODE}_{_{—}}₀ and RF_{GC}_{_{—}}_{MODE}_{_{—}}₂ are signals that if provided to RF amplifier 202 on the line 210 set the gain of the RF amplifier 202 to RF GAIN_{MAX} and RF GAIN_{NOM}, respectively. The selector 542 compares the signal IF_{GC} to threshold values that correspond to the operating modes of the AGC unit 200, selects a desired operating mode for the AGC 200, and generates a signal RF_{GC} on a line 550 in accordance with the desired operating mode. The selector 542 selects one of the signals RF_{GC}_{_{—}}_{MODE}_{_{—}}₀, RF_{GC}_{_{—}}_{MODE} _{_{—}}₁, RF_{GC}_{_{—}}_{MODE}_{_{—}}₂, or RF_{GC}_{_{—}}_{MODE}_{_{—}}₃ in accordance with the operating modes MODE₀, MODE₁, MODE₂, and MODE₃, respectively, to generate the signal RF_{GC}.

FIG. 6A depicts an example of a gain characteristic curve that approximates the actual gain characteristic curve of the IF amplifier 206. The gain characteristic curve of FIG. 6A is used by the selector 542 to determine the desired operating mode. Typically, the gain characteristic curve of the IF amplifier 206 maps the voltage of the signal IF_{GC} to the gain of the IF amplifier 206. However, it should be apparent that one or more parameters of the signal IF_{GC} and/or one or more other parameter(s), e.g., ambient temperature, could be used to map to the gain of the IF amplifier 206.

FIG. 6B depicts a flow chart of a control loop that illustrates operation of one embodiment of the selector 442 of the control system 108 of the AGC unit 200. A block 602 compares IF_{GC}<IF_{GC}_{_{—}}₁, and if the result of the comparison is true, a block 604 selects MODE₀ as the desired operating mode and sets RF_{GC} to RF_{GC}_{_{—}}_{MODE} _{_{—}}₀. Otherwise, a block 606 compares IF_{GC}_{_{—}}₁≦IF_{GC}<IF_{GC}_{_{—}}₂, and if the result is true, a block 608 sets the desired operating mode to MODE₁ and RF_{GC} to RF_{GC}_{_{—}}_{MODE}_{_{—}}₁. If the comparison of the block 606 is false, then a block 610 compares IF_{GC}_{_{—}}₂≦IF_{GC}<IF_{GC}_{_{—}}₃, and if the result is true, a block 612 sets the desired operating mode to MODE₂ and RF_{GC} to RF_{GC}_{_{—}}_{MODE}_{_{—}}₂. If none of the comparisons of the blocks 602, 606, and 610 generates a positive result (i.e., IF_{GC}>IF_{GC}_{_{—}}₃), a block 614 sets the desired operating mode to MODE₃ and RF_{GC} to RF_{GC}_{_{—}}_{MODE}_{_{—}}₃. After selecting the desired operating mode and the value of the signal RF_{GC}, control from the blocks 604, 608, 612, and 614 returns to the block 602.

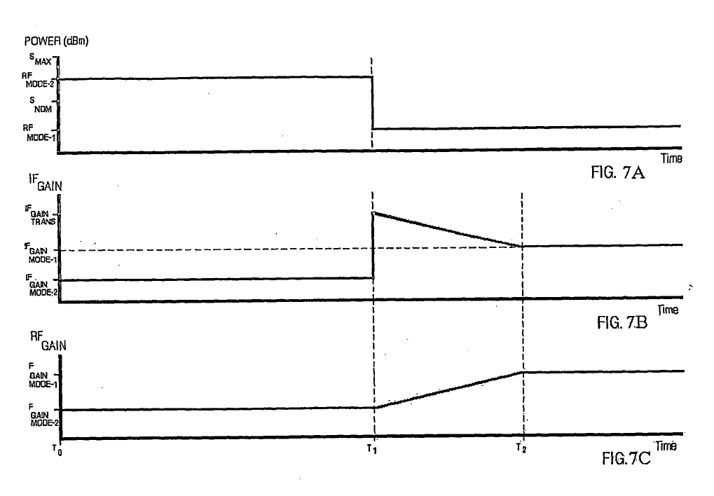

Referring once again to FIG. 2, some embodiments of the AGC unit 200, incorporate an IF amplifier 206 having a wider bandwidth than the RF amplifier 202 wherein the IF_{GAIN} can be adjusted faster than the RF_{GAIN}. During operation, the AGC unit 200 may be required to quickly transition between operating modes in response to sudden changes in the input signal power level. In response, the IF_{GAIN} can be immediately adjusted to compensate for the sudden change in the input signal and for the slower response of the RF amplifier 202. The RF GAIN CONTROL and IF GAIN CONTROL signals on the lines 210 and 212, respectively, are thereafter adjusted simultaneously until the RF_{GAIN} and IF_{GAIN} gains reach levels that are in accordance with the new operating mode of the AGC unit 200. As an example, consider the behavior over time of a received signal depicted in FIG. 7A, where the power level of the received signal at time T₀ is at a level RF_{MODE-2} less than S_{MAX} and greater than S_{NOM}. At time T₁, the power level of the signal drops to a power level RF_{MODE-1} that is less than S_{NOM} and greater than S_{MIN}. In accordance with FIGS. 3A and 3B the AGC unit 200 is operated at 316 in MODE₂ during the time period between times T₀ and T₁ and is operated at 314 in MODE₁ after time T₁. FIGS. 7B and 7C show how the RF_{GAIN} and the IF_{GAIN} are adjusted in response to the signal power level behavior depicted in FIG. 7A. During the period of time when the AGC unit 200 is operating in MODE₂ (i.e., between times T₀ and T₁), the IF_{GAIN} is set to IF_{GAIN-MODE-2} and the RF_{GAIN} is set to RF_{GAIN-MODE-2}. At time T₁ the AGC unit 200 begins a transition from MODE₂ to MODE₁ in response to the change in the power level of the input signal depicted in FIG. 7A. The AGC unit 200 enters a transition period by immediately increasing the IF_{GAIN} to IF_{GAIN-TRANS} and slewing the RF_{GAIN} from RF_{GAIN-MODE-2} to RF_{GAIN-MODE-1}. The value of IF_{GAIN-TRANS} is selected to compensate for the new power level of the received signal. In the example depicted by FIGS. 7A-7C, the transition period occupies the period of time between times T₁ and T₂ during which the RF_{GAIN} is increased and the IF_{GAIN} is decreased. The transition period ends when the RF_{GAIN} and the IF_{GAIN} reach levels dictated by the new mode of operation of the AGC unit 200. The control system operates the AGC unit 200 to compensate for fast changes in signal power while minimizing distortion. It should be apparent to those of skill in the art that similar variations in the gains of the amplifiers would be appropriate during other transition periods.

Some embodiments integrate the control system 108 with the circuitry of the demodulator 104 of the receiver 100. Other embodiments implement the entire analog front end 102 as part of the demodulator 104 circuitry of the receiver. Yet other embodiments implement the AGC 200 as part of the demodulator 108. Other combinations should be apparent to those of skill in the art.

Variations in the implementation of the invention will occur to those of skill in the art. Illustratively, some or all of the generation and calculation of signals can be performed by application-specific or general-purpose integrated circuits, by discrete components, or in software. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

I/We claim:

1. An automatic gain control (AGC) circuit comprising an RF amplifier having first and second distinct active gain control regions wherein a gain of the RF amplifier varies during operation in the active gain control regions.

2. The AGC circuit of claim 1, wherein the first active gain control region is separated from the second active gain control region by an intermediate region, and wherein a gain characteristic of the intermediate region comprises a constant gain.

3. The AGC circuit of claim 1, wherein a gain characteristic of the first active gain control region is linear as a function of received power.

4. The AGC circuit of claim 1, wherein a gain characteristic of the second active gain control region is linear as a function of received power.

5. The AGC circuit of claim 1, wherein a gain of the RF amplifier decreases as received power level increases during operation in the first active gain control region.

6. The AGC circuit of claim 1, wherein a gain of the RF amplifier decreases as received power level increases during operation in the second active gain control region.

7. The AGC circuit of claim 1, wherein the first active gain control region is adjacent a low power region and wherein a gain characteristic of the low power region comprises a constant gain.

8. The AGC circuit of claim 2, further comprising an IF amplifier, wherein a gain characteristic of the IF amplifier is maintained at a constant gain during operation in the active control regions.

9. The AGC circuit of claim 8, further including a down converter operationally coupled between an output of the RF amplifier and the input of the IF amplifier.

10. The AGC circuit of claim 1, wherein the AGC circuit generates a signal at a constant power level.

11. A circuit for amplifying a signal, comprising:
a first amplifier that develops a first amplified signal from the signal, wherein a first gain is associated with the first amplifier;
a second amplifier that generates a second amplified signal from a signal derived from the first amplifier signal, wherein a second gain is associated with the second amplifier; and
a controller responsive to the power level of the signal that selects an operating mode for the circuit from at least three operating modes and controls the first gain and the second gain in accordance with the operating mode.

12. The circuit of claim 11, further including a down converter operationally coupled between an output of the first amplifier and an input of the second amplifier.

13. The circuit of claim 11, wherein the controller controls the first gain and the second gain simultaneously in response to the power level.

14. The circuit of claim 11, wherein a first predetermined range of levels is associated with the operating mode and the first gain is selected from the first predetermined range of levels.

15. The circuit of claim 11, wherein a second predetermined range of levels is associated with the operating mode and the second gain is selected from the second predetermined range of levels.

16. The circuit of claim 11, wherein the first gain is allowed to vary during operation in two of the operating modes.

17. The circuit of claim 11, wherein the first amplifier is an RF amplifier.

18. The circuit of claim 11, wherein the second amplifier is an IF amplifier.
